(19) United States
(12) Patent Application Publication
(10) Pub. No.: US 2024/0284525 A1
(43) Pub. Date: Aug. 22, 2024

(54) METHOD FOR CONNECTION ESTABLISHMENT, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Jiangsheng FAN, Dongguan (CN); Shukun WANG, Dongguan (CN)

(21) Appl. No.: 18/630,451

(22) Filed: Apr. 9, 2024

Related U.S. Application Data
(63) Continuation of application No. PCT/CN2021/124171, filed on Oct. 15, 2021.

(51) Int. Cl. H04W 76/10; H04W 60/04; H04W 74/0836; H04W 76/40

(52) U.S. Cl. CPC H04W 76/10; H04W 60/04; H04W 74/0836; H04W 76/40

(57) ABSTRACT

The disclosure relates to a method for connection establishment, a terminal device, and a network device. The method includes the following. A terminal device transmits a first sequence to a network device during connection establishment with the network device. The first sequence indicates first identification information, and the first identification information is used to identify the terminal device.

### CROSS-REFERENCE TO RELATED APPLICATION(S)

This application is a continuation of International Application No. PCT/CN2021/124171, filed Oct. 15, 2021, the entire disclosure of which is incorporated herein by reference.

### TECHNICAL FIELD

This disclosure relates to the field of communications, and in particular, to a method for connection establishment, a terminal device, and a network device.

### BACKGROUND

During connection establishment between a terminal device and a network device, the core task is to make the network device identify an identity of the terminal device to prepare for subsequent transmission and reception of user data. Currently, in a communication system, in the case where a terminal device in an idle state or in an inactive state wants to enter a connected state, a 2-step random access (RA) procedure or a 4-step RA procedure may be adopted to realize access. However, the above connection establishment is time-consuming or has too high requirements on terminal device capability, which is not suitable for some communication scenarios such as an internet of things (IoT) communication scenario. Therefore, there is an urgent need for an efficient manner for connection establishment that has relatively low requirements on terminal device capability.

### SUMMARY

In view of above, a method for connection establishment, a terminal device, and a network device are provided in embodiments of the disclosure.

A method for connection establishment is provided in embodiments of the disclosure. The method includes the following. A terminal device transmits a first sequence to a network device during connection establishment with the network device. The first sequence indicates first identification information, and the first identification information is used to identify the terminal device.

A terminal device is provided in embodiments of the disclosure. The terminal device includes a transceiver, a processor coupled to the transceiver, and a memory storing a computer program which, when executed by the processor, causes the terminal device to transmit a first sequence to a network device during connection establishment with the network device. The first sequence indicates first identification information, and the first identification information is used to identify the terminal device.

A network device is provided in embodiments of the disclosure. The network device includes a transceiver, a processor coupled to the transceiver, and a memory storing a computer program which, when executed by the processor, causes the network device to receive a first sequence transmitted by a terminal device during connection establishment with the terminal device. The second processing module is configured to determine first identification information according to the first sequence. The first identification information is used to identify the terminal device.

Other features and aspects of the disclosed features will become apparent from the following detailed description, taken in conjunction with the accompanying drawings, which illustrate, by way of example, the features in accordance with implementations the disclosure. The summary is not intended to limit the scope of any implementations described herein.

### BRIEF DESCRIPTION OF THE DRAWINGS

FIG. 1 is a schematic diagram illustrating a communication system architecture in embodiments of the disclosure.

FIG. 2 is a schematic diagram illustrating 4-step random access channel (RACH) in embodiments of the disclosure.

FIG. 3 is a schematic diagram illustrating 2-step RACH in embodiments of the disclosure.

FIG. 4 is a schematic flow chart illustrating a method for connection establishment in an embodiment of the disclosure.

FIG. 5 is a schematic flow chart illustrating a method for connection establishment in another embodiment of the disclosure.

FIG. 6 is a schematic structural block diagram illustrating a terminal device in an embodiment of the disclosure.

FIG. 7 is a schematic structural block diagram illustrating a terminal device in another embodiment of the disclosure.

FIG. 8 is a schematic structural block diagram illustrating a network device in another embodiment of the disclosure.

FIG. 9 is a schematic block diagram illustrating a communication device in embodiments of the disclosure.

FIG. 10 is a schematic block diagram illustrating a chip in embodiments of the disclosure.

FIG. 11 is a schematic block diagram illustrating a communication system in embodiments of the disclosure.

### DETAILED DESCRIPTION

The following will describe technical solution in embodiments of the disclosure with reference to accompanying drawings in embodiments of the disclosure.

The technical solutions in embodiments of the disclosure can be applicable to various communication systems, for example, a global system of mobile communication (GSM), a code division multiple access (CDMA) system, a wideband code division multiple access (WCDMA) system, a general packet radio service (GPRS) system, a long term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (Wi-Fi), a 5th-generation (5G) system, or other communication systems.

Generally speaking, a conventional communication system supports a limited number of connections and therefore is easy to implement. However, with development of communication technology, a mobile communication system not only supports conventional communication but also supports, for example, device to device (D2D) communication, machine to machine (M2M) communication, machine type communication (MTC), and vehicle to vehicle (V2V) communication. Embodiments herein can also be applicable to these communication systems.

Optionally, a communication system in embodiments of the disclosure can be applicable to a carrier aggregation (CA) scenario, a dual connectivity (DC) scenario, and a standalone (SA) scenario.

In embodiments of the disclosure, each embodiment is illustrated with respective to a network device and a terminal device, where the terminal device may also be called a user equipment (UE), an access terminal, a subscriber unit, a subscriber station, a mobile station, a mobile platform, a remote station, a remote terminal, a mobile device, a user terminal, a terminal, a wireless communication device, a user agent, a user apparatus, etc.

The terminal device may also be a station (ST) in the WLAN, a cellular radio telephone, a cordless telephone, a session initiation protocol (SIP) telephone, a wireless local loop (WLL) station, a personal digital assistant (PDA). The terminal device may also be a device with wireless communication functions such as a handheld device, a computing device, other processing devices coupled with a wireless modem, an in-vehicle device, a wearable device, or a terminal device in a next-generation communication system such as an NR network, a terminal device in a future evolved common land mobile network (PLMN), etc.

In embodiments of the disclosure, the terminal device can be deployed on land, including indoor or outdoor, handheld, wearable, or vehicle-mounted; on water (e.g., a ship); and also in the air (e.g., an aircraft, a balloon, and a satellite).

In embodiments of the disclosure, the terminal device may be a mobile phone, a pad, a computer with wireless transceiving functions, a terminal device for virtual reality (VR), a terminal device for augmented reality (AR), a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, etc.

As an example but not limitation, in embodiments of the disclosure, the terminal device may also be a wearable device. The wearable device can also be called a wearable smart device, which is a collective name of wearable devices intelligently designed and developed by applying a wearable technology to daily wear, such as glasses, gloves, watches, clothing, shoes, etc. The wearable device is a portable device that can be worn directly on the body or integrated into clothing or accessories of a user. The wearable device not only is a hardware device but also can realize powerful functions through software support, data interaction, and cloud interaction. Broadly speaking, the wearable smart device includes a device that has full functions and a large size and can realize all or part of functions without relying on a smart phone, e.g., a smart watch, smart glasses, or the like, and includes a device that only focuses on a certain application function and needs to be used with other devices such as a smart phone, e.g., all kinds of smart bracelets and smart jewelry for physical sign monitoring or the like.

In embodiments of the disclosure, the network device may be a device that is used to communicate with a mobile device. The network device may be an access point (AP) in the WLAN, a base transceiver station (BTS) in the GSM or CDMA system, a NodeB (NB) in the WCDMA system, or an evolved NodeB (eNB or eNodeB) in the LTE system. Alternatively, the network device may also be a relay station, an AP, an in-vehicle device, a wearable device, a network device (a generation NodeB (gNB)) in the NR network, or a network device in the future evolved PLMN. The network device may also be a core network (CN) device.

As an example but not limitation, in embodiments of the disclosure, the network device can have a mobility, e.g., the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may also be a base station deployed on land, on water, or on other locations.

In embodiments of the disclosure, the network device can provide a service for a cell, and the terminal device can communicate with the network device through transmission resources (e.g., frequency-domain resources or spectrum resources) for the cell, where the cell may be a cell corresponding to the network device (e.g., a base station). The cell may belong to a macro base station or a base station corresponding to a small cell, where the small cell may include a metro cell, a micro cell, a pico cell, a femto cell, or the like. These small cells have features of small coverage ranges and low transmission power and are suitable for providing high-speed data transmission services.

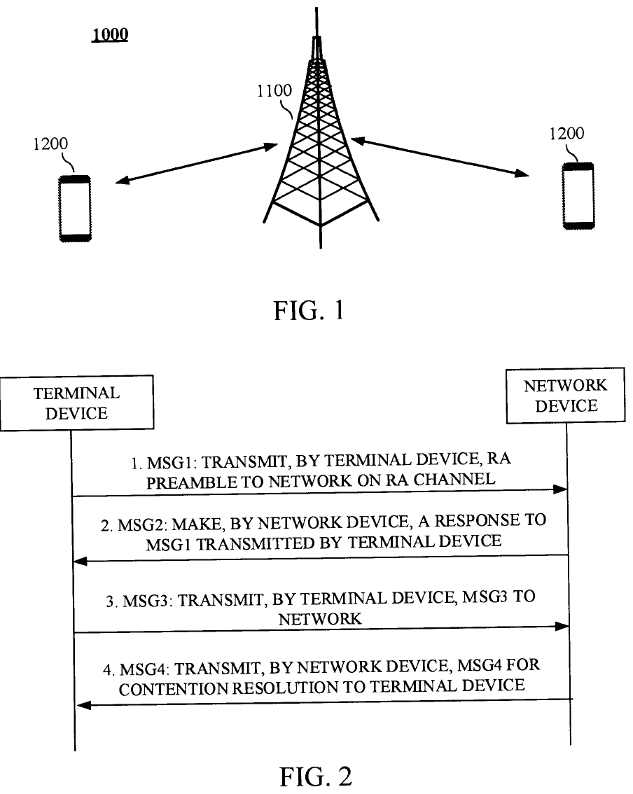

FIG. 1 exemplarily illustrates a radio access system 1000. The radio access system 1000 includes a network device 1100 and two terminal devices 1200. Optionally, the wireless communication system 1000 may include multiple network devices 1100, and the other number of terminal devices may be included in a coverage range of each of the multiple network devices 1100, which is not be limited in embodiments of the disclosure. Optionally, the communication system 1000 illustrated in FIG. 1 may further include a mobility management entity (MME), an access and mobility management function (AMF), or other network entities, which is not be limited in embodiments of the disclosure.

It may be understood that, a device with a communication function in a network/system in embodiments of the disclosure can be called a communication device. Taking the communication system illustrated in FIG. 1 as an example, communication devices may include the network device and the terminal device that have communication functions, and the network device and the terminal device may be the specific devices in embodiments of the disclosure, which will not be repeated herein. The communication devices may further include other devices in the communication system, e.g., a network controller, an MME, or other network entities, which is not limited in embodiments of the disclosure.

It may be understood that, the terms “system” and “network” in this disclosure are often used interchangeably. The term “and/or” in this disclosure is an illustration of an association relationship of associated objects, for example, indicating that three relationships may exist between the associated objects, for example, A and/or B, which may indicate the existence of A alone, A and B together, and B alone. The character “/” in this disclosure generally indicates that associated objects are in an “or” relationship.

It may be understood that, the “indication” referred to in embodiments of the disclosure may be a direct indication, an indirect indication, or an indication indicating an associated relation. For example, A indicates B, which can mean that A indicates B directly, e.g., B can be obtained through A, can also mean that A indicates B indirectly, e.g., A indicates C, and B can be obtained through C, or can further mean that A and B have an associated relation.

In illustration of embodiments of the disclosure, the term “correspondence” may represent a direct correspondence or indirect correspondence between the two, may also represent an associated relation between the two, or may further represent a relation of indicating and being indicated, a relation of configuring and being configured, or other relations.

In order to facilitate understanding of the technical solutions in embodiments of the disclosure, the following describes the related technologies of embodiments of the disclosure. The related technologies below as an optional solution may be arbitrarily combined with the technical solutions in embodiments of the disclosure, and any combination thereof may belong to the scope of protection of embodiments of the disclosure.

### (i) 5G Technology Overview

Currently, with the pursuit of speed, delay, high-speed mobility, energy efficiency, and the diversity and complexity of services in the future life, 5G technology is rapidly developed. Primary application scenarios of the 5G include enhance mobile broadband (eMBB), ultra reliable low latency communications (URLLC), massive machine type communication (mMTC), etc.

The demand for eMBB is growing rapidly with the goal of providing users with multimedia content, services and data. On the other hand, since eMBB may be deployed in different scenarios, such as indoor, urban, rural, and the like, the capabilities and demands vary greatly, therefore, it cannot be unconditionally determined and must be analyzed in detail in the context of specific deployment scenarios. Typical applications of URLLC include: industrial automation, power automation, remote medical operation (surgery), traffic safety and security, and the like. Typical features of mMTC include: high connection density, small data volume, delay-insensitive services, low cost and long lifetime of the module, and the like.

In a 5G network environment, a new radio resource control (RRC) state, namely an RRC_INACTIVE state, has been defined to reduce air interface signaling, achieve fast radio connection recovery, and achieve fast data service recovery. Such a state is different from an RRC_IDLE state and an RRC_CONNECTED state.

RRC_IDLE (idle state): mobility is based on cell reselection of a UE, paging is initiated by a CN, and a paging area is configured by the CN. The base station side has no UE access stratum (AS) context and no RRC connection.

RRC_CONNECTED (connected state): there is an RRC connection, both the base station and a UE have a UE AS context, and a network side knows a location of the UE based on a cell level. Mobility is controlled by the network side. Unicast data can be transmitted between the UE and the base station.

RRC_INACTIVE (inactive state): mobility is based on cell reselection of the UE, there is a CN-radio access network (RAN) connection, an anchor base station has a UE AS context, paging is triggered by an RAN, an RAN-based paging area is managed by the RAN, and the network side knows the location of the UE based on a RAN-based paging area level.

### (ii) Random Access Channel (RACH)

4-step RACH is supported in NR release 15 (R15). Basic flows of 4-step RACH are illustrated in FIG. 2.

Various steps in FIG. 2 are as follows.
Step 1: a message in step 1 is referred to as message (MSG) 1. A terminal device transmits an RA preamble to a network device on an RA channel. In the procedure, the terminal device needs to select a time-frequency resource, i.e., an RA occasion (RO), to transmit the RA preamble.
Step 2: a message in step 2 is referred to as MSG2. Under normal circumstances, the network device needs to return MSG2 to the terminal device in a certain time window in response to reception of MSG1 transmitted by the terminal device. MSG2 contains information such as a scheduled resource for MSG3, a temporary cell-radio network temporary identifier (C-RNTI) allocated by a network to the terminal device for use, a timing advance (TA) estimated by the network for transmission from the terminal device to the network, and a back-off time parameter for RA failure.
Step 3: a message in step 3 is referred to as MSG3. MSG3 mainly contains information such as an identifier (ID) for the terminal device and an access cause of the terminal device.
Step 4: a message in step 4 is referred to as MSG4. MSG4 is mainly used by the network device to inform the terminal device of contention resolution and configuration information of signaling radio bearer (SRB) 1.

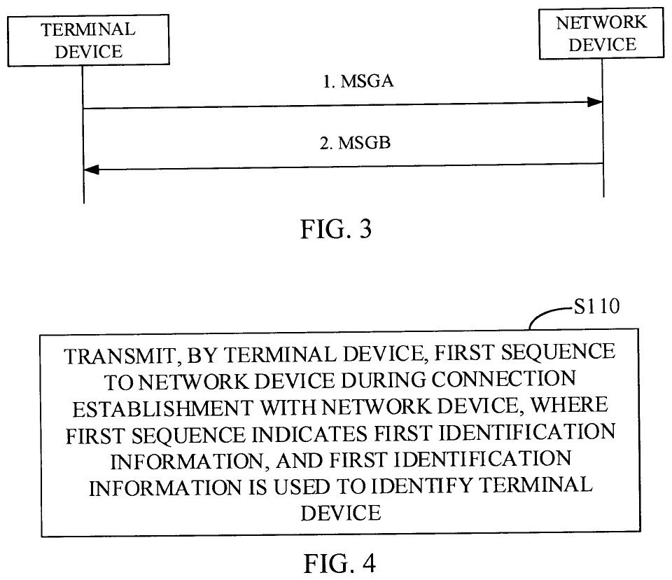

2-step RACH is newly introduced in NR R16. Basic flows of 2-step RACH are illustrated in FIG. 3.

Various steps in FIG. 3 are as follows.
Step 1: a message in step 1 is referred to as MSGA. The operation at step 1 can be understood as that MSGA is obtained by combining MSG1 and MSG3 in FIG. 2 and then transmitted.
Step 2: a message in step 2 is referred to as MSGB. The operation at step 2 can be understood as that MSGB is obtained by combining MSG2 and MSG4 in FIG. 2 and then transmitted.

The biggest advantage of 2-step RACH over 4-step RACH is shorter delay.

(iii) Terminal Devices with Ultra-Low Power Consumption or Zero Power Consumption

Interconnection of everything is one of desired visions of a communication system. Unlike a handheld terminal device, a communication terminal device connecting objects has a relatively simple function and relatively low cost requirements. There is already a low-capability internet of things (IoT) terminal device, but cost and power consumption of the IoT terminal device are still relatively high in a scenario such as smart home, security monitoring, and logistics management. In such a context, a concept of terminal devices with ultra-low power consumption or zero power consumption has been put forth. Such a terminal device supports relatively simple services, most terminal devices can only passively provide a small amount of data, and their own power consumption is close to zero. In order to meet communication needs of the terminal device with ultra-low power consumption or zero power consumption, existing complex communication procedures need to be further simplified so as to facilitate communication of the terminal device with ultra-low power consumption or zero power consumption.

During connection establishment between a terminal device and a network device, the core task is to make the network device identify an identity of the terminal device to prepare for subsequent transmission and reception of user data. Currently, in a communication system, in the case where a terminal device in an idle state or in an inactive state wants to enter a connected state, a 2-step RA procedure or a 4-step RA procedure may be adopted to realize access. The 4-step RA procedure is time-consuming and is not suitable for a delay-sensitive scenario. The 2-step RA procedure is less time-consuming than the 4-step RA procedure, but due to a relatively large amount of data carried in a physical uplink shared channel (PUSCH) for MSGA and a fact that the PUSCH for MSGA is transmitted on a common resource, successful reception of information carried in the PUSCH for MSGA by a receiving terminal, e.g., a network, requires relatively high signal quality, and a transmitting terminal, e.g., the terminal device, needs to use relatively high transmission power to effectively transmit the information carried in the PUSCH for MSGA.

For a low-cost terminal device with ultra-low power consumption or zero power consumption used in smart home, security monitoring, logistics management, and other scenarios, the connection establishment procedures described above are too slow or require a too-high terminal device capability, while high capability generally corresponds to high device cost, which is not in line with requirements of the low-cost terminal device with ultra-low power consumption or zero power consumption.

Therefore, for the low-cost terminal device with ultra-low power consumption or zero power consumption, there is an urgent need for an efficient manner for connection establishment that has relatively low requirements on terminal device capability.

Solutions provided in embodiments of the disclosure are mainly used to solve at least one of the above problems.

For more comprehensive understanding of features and technical solutions in embodiments of the disclosure, the following will describe in detail implementation of embodiments of the disclosure with reference to the accompanying drawings. The accompanying drawings are merely intended for illustration rather than limitation on the disclosure.

FIG. 4 is a schematic flow chart illustrating a method for connection establishment in an embodiment of the disclosure. The method is optionally applicable to the system illustrated in FIG. 1, but is not limited thereto. The method includes the following.

At S110, a terminal device transmits a first sequence to a network device during connection establishment with the network device. The first sequence indicates first identification information, and the first identification information is used to identify the terminal device.

Exemplarily, during connection establishment with the network device, i.e., before the terminal device and the network device perform transmission and reception of user data, the terminal device selects an available access channel resource and transmits on the available access channel resource a sequence indicating identification information of the terminal device, i.e., the first sequence. The first sequence may be an underlying signal sequence. The access channel resource is used for connection establishment performed before the terminal device and the network device perform transmission and reception of user data. Optionally, the access channel resource includes at least one of a frequency-domain resource, a time-domain resource, or a space-domain resource.

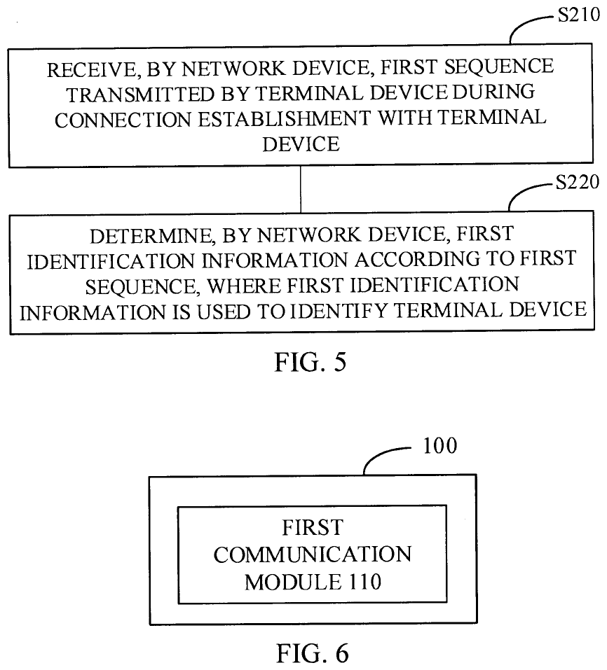

Accordingly, the network device can obtain the identification information (i.e., the first identification information) in response to successful reception of the first sequence on the access channel resource, thereby initially identifying an identity of the terminal device. FIG. 5 is a schematic flow chart illustrating a method for connection establishment according to another embodiment of the disclosure. The method includes the following.

At S210, the network device receives the first sequence transmitted by the terminal device during connection establishment with the terminal device.

At S220, the network device determines the first identification information according to the first sequence. The first identification information is used to identify the terminal device.

Optionally, the first identification information includes a terminal type of the terminal device and/or at least partial information of terminal identification for the terminal device. The terminal identification may include a terminal ID. The at least partial information of the terminal identification includes all information (or referred to as complete information) or partial information (e.g., higher-order truncated information or lower-order truncated information) for the terminal device.

Optionally, the first sequence may be in a preset correspondence with the first identification information. In this way, the terminal device first selects the first sequence corresponding to the first identification information, such as its own terminal type or terminal identification, and then transmits the first sequence to the network device. The network device may determine the first identification information according to the received first sequence and the preset correspondence.

It may be understood that in some embodiments, the terminal device needs to use the terminal identification to determine the first sequence. Optionally, the terminal identification is preconfigured or configured by the network device, where the network device may be an access network (AN) device or a CN device. That is, the terminal device may obtain the terminal identification through pre-configuration. Alternatively, the terminal device may obtain the terminal identification through interaction with network signaling. Exemplarily, the terminal device may obtain the terminal identification from the network device through registration.

Specifically, before the operation at S110, the above method further includes the following. The terminal device transmits a second sequence to the network device. The second sequence is used to initiate registration to obtain the terminal identification for the terminal device.

Accordingly, for the network device, the above method further includes the following. The network device transmits to the terminal device the terminal identification for the terminal device in response to reception of the second sequence transmitted by the terminal device.

Exemplarily, the second sequence may be a predetermined sequence dedicated to registration. Each terminal device may transmit the second sequence to indicate initiation of registration, and thus the second sequence may be referred to as a common sequence. In the case where the network device receives the second sequence and identifies that the second sequence is a sequence dedicated to registration, the network device transmits the terminal identification to the terminal device.

Optionally, the second sequence is preconfigured or configured via a first system broadcast message transmitted by the network device.

Optionally, one or more common sequences for registration may be preconfigured or configured by the network device for initiation of registration by a user. In the case where multiple common sequences for registration are configured, the terminal device may randomly select a common sequence among the multiple common sequences to initiate registration. Optionally, the multiple common sequences for registration may be obtained via one root sequence configuration or different root sequence configurations.

In the above method provided in embodiments of the disclosure, during connection establishment with the network device, the terminal device transmits a sequence to indicate identification information of the terminal device, so that identification of an identity of the terminal device by the network device may be performed as fast as possible, and user-plane data interaction with the network device may be performed as early as possible, thereby reducing delay of data interaction. Moreover, sequence transmission has low requirements on terminal device capability, which is conducive to realizing fast access to a network by a low-capability terminal device with low power consumption.

Optionally, after the network device obtains the first identification information of the terminal device in response to reception of the first sequence, the above method may include the following. The network device transmits a first response message to the terminal device. The first response message is used for instructing the terminal device to transmit a first uplink message.

Accordingly, for the terminal device, the above method further includes the following. The terminal device transmits the first uplink message to the network device in response to reception of the first response message from the network device.

Optionally, the first response message indicates at least one of a resource for uplink data transmission, a temporary scrambling code, or TA information.

Optionally, the first uplink message contains user data.

Optionally, the user data includes at least one of data pre-stored in the terminal device, data about surroundings collected by the terminal device, or data obtained by the terminal device through internal operations.

The above network device may be an AN device or a CN device.

As can be seen, in some optional examples, the network device may initially identify the terminal device according to interaction with the terminal device at step 1, and after the network device returns the first response message, user-plane data interaction may be realized at step 3. In some examples, user-plane data interaction and deep identification of the terminal device may be realized at step 3. Compared with the 4-step RA procedure, identification of the terminal device by the network device may be performed faster, and user-plane data interaction with the network device may be performed earlier.

On the other hand, in the 2-step RA procedure, interaction of the terminal identification is performed at step 1, but a sequence and a message carried in the PUSCH need to be transmitted successively in a relatively short period of time during MSGA transmission at step 1, contention resolution (i.e., the network device agrees that a certain terminal device can access a network) is performed at step 2, a resource scheduled by the network device is further accepted at step 3, and user-plane data interaction with the network device may be performed only after step 4. Therefore, compared with the 2-step RA procedure, during connection establishment in the above method, the message carried in the PUSCH does not need to be transmitted for interaction at step 1, thereby reducing requirements on transmit power of the terminal device during access and identification and facilitating realization of connection establishment by a low-cost terminal device with ultra-low power consumption or zero power consumption. In addition, in the above method, user-plane data interaction with the network device may be performed at step 3, which is faster than the operation in the 2-step RA procedure.

The methods provided in embodiments of the disclosure are applicable to not only conventional communication procedures but also communications of low-cost terminal device with ultra-low power consumption or zero power consumption, and thus the methods are applicable to various application scenarios, such as the aforementioned smart home, security monitoring, logistics management, and other scenarios. For different application scenarios or different network requirements, the methods provided in embodiments of the disclosure can be implemented in different manners. Several specific examples are provided below.

### Example 1

In the example, the first sequence corresponds to the terminal type of the terminal device. That is, the first identification information includes the terminal type, and the first sequence may indicate the terminal type.

Accordingly, the operation at S220 that the network device determines the first identification information according to the first sequence is as follows. The network device determines the terminal type of the terminal device according to the first sequence.

In the example, the terminal device performs access via the first sequence and identification of the terminal device is performed via the first sequence as follows.
Phase 1: the terminal device transmits the first sequence to the network device. The first sequence corresponds to the terminal type of the terminal device and may be referred to as a dedicated sequence. The network device identifies the terminal type of the terminal device in response to reception of the first sequence.
Phase 2: as explained previously, the network device transmits the first response message to the terminal device in response to successful reception of the first sequence transmitted by the terminal device. The terminal device transmits the first uplink message to the network device in response to reception of the first response message transmitted by the network device. Accordingly, the network device receives the first uplink message transmitted by the terminal device.

As explained previously, optionally, the first uplink message transmitted by the terminal device may contain user-plane data.

In the example, optionally, the first uplink message transmitted by the terminal device contains the terminal identification for the terminal device. In some scenarios that require a combination of the terminal type and the terminal identification, the network device may identify a unique terminal device according to the terminal type and the terminal identification.

Exemplarily, the case that the terminal device carries the terminal identification in the first uplink message may be any one of the following.
Case 1: the first uplink message contains the terminal identification for the terminal device by default.

That is to say, the terminal device needs to carry the terminal identification in the first uplink message whenever the terminal device is to transmit the first uplink message.
Case 2: a first indication transmitted by the network device is received. The first indication is used for instructing the terminal device to report the terminal identification.

That is to say, the network device may select whether or not to transmit the first indication. The above method may further include the following. The network device transmits the first indication to the terminal device. The first indication is used for instructing the terminal device to report the terminal identification. The first uplink message transmitted by the terminal device contains the terminal identification for the terminal device in the case where the first indication is received, i.e., the terminal device needs to carry the terminal identification in the first uplink message.

Optionally, the first indication may be carried in a second system broadcast message, the first response message, or first dedicated signaling.

Optionally, in the case where no terminal identification is assigned to the terminal device, i.e., in the case where the terminal device does not have valid terminal identification at a time when the terminal device initiates connection establishment (e.g., the terminal device has not performed registration before initiation of connection establishment), the first uplink message transmitted by the terminal device contains no terminal identification for the terminal device, and/or the first uplink message transmitted by the terminal device contains terminal identification generated randomly.

In the example, the first sequence corresponding to the terminal type of the terminal device may be configured according to a specific scenario, and several exemplary configuration modes for the first sequence are provided below.
Configuration mode 1: a first correspondence is preconfigured. The first sequence is determined according to the preconfigured first correspondence. The first correspondence may be a correspondence between the terminal type of the terminal device and the first sequence, or the first correspondence may be a correspondence between the terminal type of the terminal device and a root sequence configuration for the first sequence.

For example, the protocol explicitly defines a dedicated sequence for initiation of connection establishment by a terminal device of each type, i.e., explicitly defines a correspondence between terminal types and dedicated sequences. For example, terminal devices of a first type correspond to dedicated sequence 1, terminal devices of a second type correspond to dedicated sequence 2, terminal devices of a third type correspond to dedicated sequence 3, etc. The first sequence adopted by the terminal device is determined according to the correspondence, for example, a first sequence adopted by terminal devices of the first type is dedicated sequence 1. In this way, the network device can determine the terminal type according to the preconfigured correspondence and the received first sequence.

Alternatively, the protocol explicitly defines a root sequence configuration for initiation of connection establishment by a terminal device of each type, i.e., explicitly defines a correspondence between terminal types and root sequence configurations. For example, terminal devices of a first type correspond to root sequence configuration 1, terminal devices of a second type correspond to root sequence configuration 2, terminal devices of a third type correspond to root sequence configuration 3, etc. A root sequence configuration corresponding to the terminal device is determined according to the correspondence, and the terminal device may generate the first sequence according to the root sequence configuration corresponding to the terminal type of the terminal device. In this way, the network device may determine the terminal type according to the preconfigured correspondence and the received first sequence.
Configuration mode 2: the first sequence is determined according to a third system broadcast message transmitted by the network device. That is, the above method may further include the following. The network device transmits the third system broadcast message to the terminal device. The third system broadcast message is used for instructing the terminal device to determine the first sequence.

Optionally, the third system broadcast message indicates a correspondence between multiple terminal types and multiple sequence IDs. Alternatively, the third system broadcast message indicates a correspondence between multiple terminal types and multiple root sequence configurations.

Optionally, the multiple terminal types may be in a one-to-one correspondence with the multiple sequence IDs, or the multiple terminal types may be in a multiple-to-one correspondence with the multiple sequence IDs. Similarly, the multiple terminal types may be in a one-to-one correspondence with the multiple root sequence configurations, or the multiple terminal types may be in a multiple-to-one correspondence with the multiple root sequence configurations.

In the case of a one-to-one correspondence, different terminal types correspond to different sequence IDs or different root sequence configurations. In the case of a multiple-to-one correspondence, multiple terminal types may correspond to the same sequence ID or the same root sequence configuration, e.g., a set of terminal types may correspond to the same sequence ID or the same root sequence configuration, and different sets of terminal types correspond to different sequence IDs or different root sequence configurations, where each set of terminal types may include multiple terminal types.

A one-to-one correspondence is taken as an example, and the third system broadcast message transmitted by the network device may carry information in Table 1 below.

TABLE 1
correspondence between multiple terminal types and multiple
sequence IDs or correspondence between multiple terminal
types and multiple root sequence configurations

| Terminal type | Sequence ID or root sequence configuration |
|---|---|
| Terminal type ID 1 | ID of dedicated sequence 1 or configuration |
| | for root sequence 1 |
| Terminal type ID 2 | ID of dedicated sequence 2 or configuration |
| | for root sequence 2 |
| . . . | . . . |
| Terminal type ID N | ID of dedicated sequence N or configuration |
| | for root sequence N |

N is an integer greater than or equal to 1.

As illustrated in Table 1, a terminal type ID corresponds to an ID of a dedicated sequence or a root sequence configuration. The root sequence is a basic sequence for sequence generation, and generally a root sequence can derive multiple subsequences.

Optionally, in the case where the third system broadcast message indicates a correspondence between multiple terminal types and multiple sequence IDs, the multiple sequence IDs may be IDs of multiple subsequences of a first root sequence, and the first sequence is generated according to a sequence ID corresponding to the terminal type of the terminal device and the first root sequence. Accordingly, the network device may determine the sequence ID corresponding to the terminal type according to the received first sequence, and then determine the terminal type of the terminal device according to the above correspondence.

Referring to Table 1, in the case where a terminal type ID in Table 1 corresponds to an ID of a dedicated sequence, dedicated sequences 1 to N in Table 1 may share a root sequence, where the root sequence is noted as the first root sequence. The root sequence may be preconfigured, e.g. configured by a protocol by default, or the root sequence may be configured to the terminal device via a system broadcast message. Since a procedure of generating dedicated sequences 1 to N from the first root sequence is known, the terminal device determines an ID of a dedicated sequence according to its own terminal type information and the correspondence in Table 1, and thus determines a dedicated sequence to-be-transmitted, i.e., the first sequence, according to the ID of the dedicated sequence and the first root sequence.

Optionally, in the case where the third system broadcast message indicates a correspondence between multiple terminal types and multiple root sequence configurations, the first sequence is generated according to the root sequence configuration corresponding to the terminal type of the terminal device. Accordingly, the network device may determine the terminal type of the terminal device according to a root sequence corresponding to the received first sequence and the above correspondence.

Referring to Table 1, in the case where a terminal type ID in Table 1 corresponds to a root sequence configuration, the terminal device determines a root sequence configuration according to its own terminal type and the correspondence in Table 1, and then the terminal device arbitrarily selects one of at least one dedicated sequences generated according to the root sequence configuration as the first sequence.

In the case where multiple terminal types are in a multiple-to-one correspondence with multiple sequence IDs or multiple terminal types are in a multiple-to-one correspondence with multiple root sequence configurations, configuration of the first sequence adopted by the terminal device and identification by the network device are similar to those in the case where multiple terminal types are in a one-to-one correspondence with multiple sequence IDs or multiple terminal types are in a one-to-one correspondence with multiple root sequence configurations described above, which is not repeated herein.

Configuration mode 3: the first sequence is determined according to second dedicated signaling transmitted by the network device. That is, the above method may further include the following. The network device transmits the second dedicated signaling to the terminal device. The second dedicated signaling is used for instructing the terminal device to determine the first sequence.

Optionally, the second dedicated signaling indicates a sequence corresponding to the terminal type of the terminal device or the root sequence configuration corresponding to the terminal type of the terminal device. In the case where the second dedicated signaling indicates the sequence corresponding to the terminal type of the terminal device, the terminal device may directly obtain the sequence as the first sequence for initiation of connection establishment. In the case where the second dedicated signaling indicates the root sequence configuration corresponding to the terminal type of the terminal device, the terminal device may randomly select one of at least one sequence generated according to the root sequence configuration as the first sequence for initiation of connection establishment.

In practice, the terminal device does not obtain at first a sequence or a root sequence configuration configured according to dedicated signaling. The terminal device may use the first sequence determined according to aforementioned configuration mode 1 or 2 to initiate connection establishment, and the network device configures the sequence or the root sequence configuration corresponding to the terminal type via the second dedicated signaling after the network device identifies the terminal device. The terminal device determines a new first sequence in response to reception of the second dedicated signaling.

Optionally, the terminal device may transmit a third sequence to initiate connection establishment, and the network device configures the sequence or the root sequence configuration corresponding to the terminal type via the second dedicated signaling after the network device identifies the terminal device. The third sequence may be a sequence dedicated to obtaining the second dedicated signaling and may be adopted by each terminal device, i.e., the third sequence may be a common sequence or generated according to a common root sequence configuration. The common sequence or the common root sequence configuration is configured to the terminal device through pre-configuration or via a system broadcast message from the network device.

Optionally, the second dedicated signaling further indicates a valid timer associated with the sequence or the root sequence configuration corresponding to the terminal type and/or indicates valid area identification information associated with the sequence or the root sequence configuration corresponding to the terminal type.

Optionally, the above method further includes the following. The terminal device determines that the sequence provided by the second dedicated signaling or the root sequence configuration provided by the second dedicated signaling is invalid, in response to expiration of the valid timer and/or no matching between an area ID currently broadcast by the network device and the valid area identification information.

The case of expiration of the valid timer and/or no matching between the area ID currently broadcast by the network device and the valid area identification information may be set according to actual application requirements as a case of expiration of the valid timer, or a case of no matching between the area ID currently broadcast by the network device and the valid area identification information, or a case of expiration of the valid timer and no matching between the area ID currently broadcast by the network device and the valid area identification information.

Exemplarily, the valid timer and/or the valid area identification information is associated with the sequence or the root sequence configuration indicated by the second dedicated signaling, and a dedicated sequence or a dedicated root sequence configuration configured by the network device via dedicated signaling is valid only in the case where the valid timer is unexpired and/or the valid area identification information is valid. Otherwise, the dedicated sequence or the dedicated root sequence configuration configured by the network device via the dedicated signaling is invalid in the case where the valid timer expires and/or the valid area identification information is invalid.

Optionally, in the case where the sequence or the root sequence configuration provided by the second dedicated signaling is invalid, the terminal device may initiate connection establishment by using a sequence or a root sequence configuration indicated via a system broadcast message such as the third system broadcast message in configuration mode 2.

Optionally, the area ID includes a cell ID or an ID of a registered area in which a cell is located.

In the 4-step RA procedure, interaction of the identification for the terminal device is performed at step 3, contention resolution (i.e., the network device agrees that a certain terminal device can access a network) is performed at step 4, and user-plane data interaction with the network device may be performed only after step 5. Compared with the 4-step RA procedure, in the example, identification of the type of the terminal device may be realized at one step, and user-plane data interaction with the network device may be realized at step 3 (in a scenario where the first uplink message does not contain the terminal identification). Alternatively, in the example, identification of the type of the terminal device may be realized at one step, and user-plane data interaction with the network device and identification of the terminal identification may be realized at step 3 (in a scenario where the first uplink message contains the terminal identification), so that not only identification of the terminal device by the network device may be performed faster, but also user-plane data interaction with the network device may be performed earlier.

On the other hand, in the 2-step RA procedure, interaction of the terminal identification is performed at step 1, but two kinds of contents, i.e., a sequence and a message carried in the PUSCH, need to be transmitted successively in a relatively short period of time during MSGA transmission at step 1, contention resolution (i.e., the network device agrees that a certain terminal device can access a network) is performed at step 2, a resource scheduled by the network device is further accepted at step 3, and user-plane data interaction with the network device may be performed only after step 4. Compared with the conventional 2-step RA procedure, in the example, identification of the type of the terminal device may be realized at one step, which is similar to the operation at step 1 of the conventional 2-step access procedure. However, in the example, there is no need to transmit the message carried in the PUSCH, thereby reducing requirements on transmit power of the terminal device during access and identification. On another hand, in the example, user-plane data interaction with the network device may be performed at step 3, which is faster than the operation in the 2-step RA procedure.

### Example 2

In the example, a logical position number for the first sequence corresponds to first partial information of the terminal identification for the terminal device. That is to say, the first identification information includes the first partial information of the terminal identification, and the first sequence may indicate the first partial information of the terminal identification.

Accordingly, the operation at S220 that the network device determines the first identification information according to the first sequence is as follows. The network device determines, according to the first sequence, the first partial information of the terminal identification for the terminal device.

In the example, the terminal device performs access via the first sequence and identification of the terminal device is performed via the first sequence, which may include two phases, where the terminal device informs the network device of its own terminal identification in two phases.
Phase 1: the terminal device transmits the first sequence to the network device.

The first sequence may be one of at least one sequence generated according to a second root sequence. The second root sequence and/or the at least one sequence may be a sequence configuration that can be used by each terminal device for initiation of connection establishment, and thus the second root sequence may be referred to as a common root sequence and/or the at least one sequence may be referred to as a at least one common sequence. Each sequence generated by a root sequence may have a logical position number, and in the example, a logical position number for the common root sequence is used to represent the first partial information of the terminal identification. The terminal device may select a common sequence from the at least one common sequence generated by the common root sequence, where the common sequence has a logical position number same as the first partial information, and the terminal device assigns the common sequence as the first sequence to indirectly provide the first partial information of the terminal identification to the network device. In other words, although the first sequence itself is not directly related to the terminal identification, the logical position number for the first sequence is known to the network device, and thus the network device may extract the first partial information of the terminal identification according to the received logical position number for the first sequence.

Optionally, the second root sequence or the at least one sequence is preconfigured or configured via a fourth system broadcast message transmitted by the network device.

Optionally, the first partial information is a higher-order truncated portion of the terminal identification (e.g., first 6 bits of 12-bit terminal identification) or a lower-order truncated portion of the terminal identification (e.g., last 6 bits of the 12-bit terminal identification), which is not limited in the disclosure.

For example, a root sequence may generate 64 common subsequences, and each common subsequence corresponds to a 6-bit logical position number. In the case where a first portion, i.e., 6 bits, of the terminal identification takes a value of “101010”, the terminal device selects a common subsequence with a logical position number equal to “101010” from the 64 common subsequences and transmits the common subsequence to the network device, and the network device may know that the first portion, i.e., 6 bits, of the terminal identification takes the value of “101010” upon reception of the common subsequence.
Phase 2: as explained previously, the network device transmits the first response message to the terminal device in response to successful reception of the first sequence transmitted by the terminal device. The terminal device transmits the first uplink message to the network device in response to reception of the first response message transmitted by the network device.

As explained previously, optionally, the first uplink message transmitted by the terminal device may contain user-plane data.

In the example, optionally, the first uplink message transmitted by the terminal device contains second partial information of the terminal identification for the terminal device.

Exemplarily, complete terminal identification may be obtained according to the first partial information and the second partial information. For example, the first partial information is a higher-order truncated portion of the terminal identification, and the second partial information is a lower-order truncated portion of the terminal identification. For another example, the first partial information is a lower-order truncated portion of the terminal identification, and the second partial information is a higher-order truncated portion of the terminal identification.

For the network device, the above method further includes the following. The network device receives the first uplink message transmitted by the terminal device. The first uplink message contains the second partial information of the terminal identification for the terminal device. The network device determines the terminal identification for the terminal device according to the first partial information and the second partial information of the terminal identification.

Compared with the 4-step RA procedure or the 2-step RA procedure, beneficial effect in the example is similar to that in example 1, which is not repeated herein. Furthermore, in the example, the logical position number for the first sequence selected in phase 1 may represent a portion of the terminal identification, and thus less system overhead is consumed compared with that the terminal device directly provides complete identification information.

### Example 3

In the example, the first sequence corresponds to the terminal identification for the terminal device. Specifically, the first sequence corresponds to all information of the terminal identification or corresponds to the complete terminal identification. That is to say, the first identification information includes the terminal identification, and the first sequence may indicate the terminal identification.

Accordingly, the operation at S220 that the network device determines the first identification information according to the first sequence is as follows. The network device determines the terminal identification for the terminal device according to the first sequence.

In the example, each terminal device corresponds to a sequence or a root sequence, and thus the sequence may be referred to as a dedicated sequence and the root sequence may be referred to as a dedicated root sequence. The terminal device initiates connection establishment by assigning its own corresponding dedicated sequence as the first sequence, or selecting one of at least one sequence generated according to its own corresponding dedicated root sequence as the first sequence. The network device may identify a unique terminal device in response to successful reception of the dedicated sequence.

Optionally, the terminal device obtains its own corresponding dedicated sequence or its own corresponding dedicated root sequence in at least one of the following.

Configuration mode 1: the terminal device obtains its own corresponding dedicated sequence or its own corresponding dedicated root sequence through pre-configuration (e.g., a definition procedure by the protocol by default).

That is to say, the correspondence between the first sequence and the terminal identification is preconfigured.

Configuration mode 2: the terminal device obtains its own corresponding dedicated sequence or its own corresponding dedicated root sequence by receiving a system broadcast message transmitted by the network device.

Specifically, the above method further includes the following. The network device transmits a fifth system broadcast message to the terminal device. The fifth system broadcast message indicates a sequence or a root sequence corresponding to each of multiple terminal identification.

That is to say, the first sequence is determined according to the fifth system broadcast message transmitted by the network device.

Configuration mode 3: the terminal device obtains its own corresponding dedicated sequence or its own corresponding dedicated root sequence by receiving dedicated signaling transmitted by the network device.

Specifically, the above method further includes the following. The network device transmits third dedicated signaling to the terminal device. The third dedicated signaling indicates a sequence or a root sequence corresponding to the terminal identification for the terminal device.

That is to say, the first sequence is determined according to the third dedicated signaling transmitted by the network device.

Optionally, the third dedicated signaling further indicates a valid timer associated with the sequence corresponding to the terminal identification and/or indicates valid area identification information associated with the sequence corresponding to the terminal identification.

That is to say, in the case where the network device configures for the terminal device the dedicated sequence or the dedicated root sequence configuration via the dedicated signaling, the network device further configures the valid timer and/or the valid area identification information. The valid timer and/or the valid area identification information is associated with the dedicated sequence or the dedicated root sequence configuration configured by the network device, and the dedicated sequence or the dedicated root sequence configuration configured by the network device is valid only in the case where the valid timer is unexpired and/or the valid area identification information is valid. Otherwise, the dedicated sequence or the dedicated root sequence configuration configured by the network device is invalid in the case where the valid timer expires and/or the valid area identification information is invalid. After the dedicated configuration is invalid, the terminal device may only use the common sequence or the common root sequence configuration described above to initiate connection establishment.

Exemplarily, in response to expiration of the valid timer and/or no matching between the area ID currently broadcast by the network device and the valid area identification information, the terminal device determines that the sequence or the root sequence provided by the third dedicated signaling is invalid. The sequence or the root sequence provided by the third dedicated signaling is invalid.

Optionally, in the case where the sequence or the root sequence provided by the third dedicated signaling is invalid, the terminal device may initiate connection establishment by using a sequence or a root sequence indicated via a system broadcast message such as the fifth system broadcast message in configuration mode 2.

Optionally, the area ID includes a cell ID or an ID of a registered area in which a cell is located.

Compared with the 4-step RA procedure or the 2-step RA procedure, in the example, the network device may identify the terminal device faster.

The above describes the specific settings and implementation manners of embodiments of the disclosure from different perspectives by means of multiple embodiments. With at least one of the above embodiments, during connection establishment with the network device, the terminal device transmits a sequence to indicate identification information of the terminal device, so that identification of an identity of the terminal device by the network device may be performed as fast as possible, and user-plane data interaction with the network device may be performed as early as possible, thereby reducing delay of data interaction. Moreover, sequence transmission has low requirements on terminal device capability, which is conducive to realizing fast access to a network by a low-capability terminal device with low power consumption.

Correspondingly to the processing method in at least one of embodiments above, a terminal device 100 is further provided in embodiments of the disclosure. Referring to FIG. 6, the terminal device 100 includes a first communication module 110. The first communication module 110 is configured to transmit a first sequence to a network device during connection establishment with the network device. The first sequence indicates first identification information, and the first identification information is used to identify the terminal device 100.

Optionally, the first identification information includes a terminal type of the terminal device 100 and/or at least partial information of terminal identification for the terminal device 100.

Optionally, the terminal identification is preconfigured or configured by the network device.

Optionally, the first communication module 110 is further configured to transmit a second sequence to the network device. The second sequence is used to initiate registration to obtain the terminal identification for the terminal device 100.

Optionally, the second sequence is preconfigured or configured via a first system broadcast message transmitted by the network device.

Optionally, the first communication module 110 is further configured to transmit a first uplink message to the network device in response to reception of a first response message from the network device.

Optionally, the first response message indicates at least one of a resource for uplink data transmission, a temporary scrambling code, or TA information.

Optionally, the first uplink message contains user data.

Optionally, the user data includes at least one of data pre-stored in the terminal device 100, data about surroundings collected by the terminal device 100, or data obtained by the terminal device 100 through internal operations.

Optionally, the first sequence corresponds to the terminal type of the terminal device 100.

Optionally, the first uplink message transmitted by the terminal device 100 contains the terminal identification for the terminal device 100.

Optionally, the first uplink message transmitted by the terminal device 100 contains the terminal identification for the terminal device 100 in the case where a first indication is received, where the first indication is used for instructing the terminal device 100 to report the terminal identification.

Optionally, the first indication is carried in a second system broadcast message transmitted by the network device, the first response message transmitted by the network device, or first dedicated signaling transmitted by the network device.

Optionally, the first uplink message transmitted by the terminal device 100 contains no terminal identification for the terminal device 100 in the case where no terminal identification is assigned to the terminal device 100.

Optionally, the first uplink message transmitted by the terminal device 100 contains terminal identification generated randomly in the case where no terminal identification is assigned to the terminal device 100.

Optionally, the first sequence is determined according to a preconfigured first correspondence.

Optionally, the first correspondence is a correspondence between the terminal type of the terminal device 100 and the first sequence.

Optionally, the first correspondence is a correspondence between the terminal type of the terminal device 100 and a root sequence configuration for the first sequence.

Optionally, the first sequence is determined according to a third system broadcast message transmitted by the network device.

Optionally, the third system broadcast message indicates a correspondence between multiple terminal types and multiple sequence IDs.

Optionally, the multiple sequence IDs are IDs of multiple subsequences of a first root sequence, and the first sequence is generated according to a sequence ID corresponding to the terminal type of the terminal device 100 and the first root sequence.

Optionally, the multiple terminal types are in a one-to-one correspondence with the multiple sequence IDs, or the multiple terminal types are in a multiple-to-one correspondence with the multiple sequence IDs.

Optionally, the third system broadcast message indicates a correspondence between multiple terminal types and multiple root sequence configurations.

Optionally, the first sequence is generated according to a root sequence configuration corresponding to the terminal type of the terminal device 100.

Optionally, the multiple terminal types are in a one-to-one correspondence with the multiple root sequence configurations, or the multiple terminal types are in a multiple-to-one correspondence with the multiple root sequence configurations.

Optionally, the first sequence is determined according to second dedicated signaling transmitted by the network device.

Optionally, the second dedicated signaling indicates a sequence or a root sequence configuration corresponding to the terminal type of the terminal device 100.

Optionally, the second dedicated signaling further indicates a valid timer associated with the sequence or the root sequence configuration corresponding to the terminal type and/or indicates valid area identification information associated with the sequence or the root sequence configuration corresponding to the terminal type.

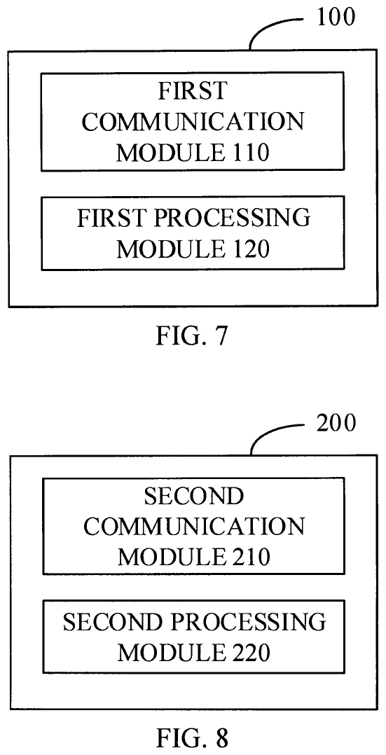

Optionally, referring to FIG. 7, the terminal device 100 may further include a first processing module 120. The first processing module 120 is configured to determine that the sequence provided by the second dedicated signaling or the root sequence configuration provided by the second dedicated signaling is invalid, in response to expiration of the valid timer and/or no matching between an area ID currently broadcast by the network device and the valid area identification information.

Optionally, the area ID includes a cell ID or an ID of a registration area in which a cell is located.

Optionally, a logical position number for the first sequence corresponds to first partial information of the terminal identification for the terminal device 100.

Optionally, the first partial information is a higher-order truncated portion of the terminal identification or a lower-order truncated portion of the terminal identification.

Optionally, the first uplink message transmitted by the terminal device 100 contains second partial information of the terminal identification for the terminal device 100.

Optionally, the first sequence is one of at least one sequence generated according to a second root sequence.

Optionally, the second root sequence or the at least one sequence is preconfigured or configured via a fourth system broadcast message transmitted by the network device.

Optionally, the first sequence corresponds to the terminal identification for the terminal device 100.

Optionally, a correspondence between the first sequence and the terminal identification is preconfigured.

Optionally, the first sequence is determined according to a fifth system broadcast message transmitted by the network device, where the fifth system broadcast message indicates a sequence or a root sequence corresponding to each of multiple terminal identification.

Optionally, the first sequence is determined according to third dedicated signaling transmitted by the network device, where the third dedicated signaling indicates a sequence or a root sequence corresponding to the terminal identification for the terminal device 100.

Optionally, the third dedicated signaling further indicates a valid timer associated with the sequence or the root sequence corresponding to the terminal identification and/or indicates valid area identification information associated with the sequence or the root sequence corresponding to the terminal identification.

The terminal device 100 in embodiments of the disclosure can implement corresponding functions of the network device in the foregoing method embodiments. For processes, functions, implementation manners, and beneficial effects corresponding to various modules (sub-modules, units, components, etc.) in the terminal device 100, reference can be made to the corresponding illustration in the foregoing method embodiments, which will not be repeated herein. It needs to be noted that, the described functions of various modules (sub-modules, units, components, etc.) in the terminal device 100 in embodiments of the disclosure can be implemented by different modules (sub-modules, units, components, etc.) or by the same module (sub-module, unit, component, etc.). For example, the first transmitting module and the second transmitting module may be different modules or the same module, and can implement corresponding functions of the network device in embodiments of the disclosure. In addition, the communication module in the embodiments of the disclosure can be implemented through a transceiver of the device, and some or all of the other modules can be implemented through a processor of the device.

FIG. 8 is a schematic block diagram illustrating a network device 200 in an embodiment of the disclosure. The network device 200 includes a second communication module 210 and a second processing module 220. The second communication module 210 is configured to receive a first sequence transmitted by a terminal device during connection establishment with the terminal device. The second processing module 220 is configured to determine first identification information according to the first sequence. The first identification information is used to identify the terminal device.

Optionally, the first identification information includes a terminal type of the terminal device and/or at least partial information of terminal identification for the terminal device.

Optionally, the second communication module 210 is further configured to transmit to the terminal device the terminal identification for the terminal device in response to reception of a second sequence transmitted by the terminal device.

Optionally, the second sequence is preconfigured or configured via a first system broadcast message transmitted by the network device 200.

Optionally, the second communication module 210 is further configured to transmit a first response message to the terminal device, where the first response message is used for instructing the terminal device to transmit a first uplink message.

Optionally, the first response message indicates at least one of a resource for uplink data transmission, a temporary scrambling code, or TA information.

Optionally, the first uplink message contains user data.

Optionally, the user data includes at least one of data pre-stored in the terminal device, data about surroundings collected by the terminal device, or data obtained by the terminal device through internal operations.

Optionally, the second processing module 220 is specifically configured to determine, by the network device 200, a terminal type of the terminal device according to the first sequence.

Optionally, the second communication module 210 is further configured to receive the first uplink message transmitted by the terminal device, where the first uplink message contains the terminal identification for the terminal device.

Optionally, the second communication module 210 is further configured to transmit a first indication to the terminal device, where the first indication is used for instructing the terminal device to report the terminal identification.

Optionally, the first indication is carried in a second system broadcast message, the first response message, or first dedicated signaling.

Optionally, the second communication module 210 is further configured to transmit a third system broadcast message to the terminal device. The third system broadcast message is used for instructing the terminal device to determine the first sequence.

Optionally, the third system broadcast message indicates a correspondence between multiple terminal types and multiple sequence IDs.

Optionally, the multiple sequence IDs are IDs of multiple subsequences of a first root sequence, and the first sequence is generated according to a sequence ID corresponding to the terminal type of the terminal device and the first root sequence.

Optionally, the multiple terminal types are in a one-to-one correspondence with the multiple sequence IDs, or the multiple terminal types are in a multiple-to-one correspondence with the multiple sequence IDs.

Optionally, the third system broadcast message indicates a correspondence between multiple terminal types and multiple root sequence configurations.

Optionally, the first sequence is generated according to a root sequence configuration corresponding to the terminal type of the terminal device.

Optionally, the multiple terminal types are in a one-to-one correspondence with the multiple root sequence configurations, or the multiple terminal types are in a multiple-to-one correspondence with the multiple root sequence configurations.

Optionally, the second communication module 210 is further configured to transmit second dedicated signaling to the terminal device. The second dedicated signaling is used for instructing the terminal device to determine the first sequence.

Optionally, the second dedicated signaling indicates a sequence or a root sequence configuration corresponding to the terminal type of the terminal device.

Optionally, the second dedicated signaling further indicates a valid timer associated with the sequence or the root sequence configuration corresponding to the terminal type and/or indicates valid area identification information associated with the sequence or the root sequence configuration corresponding to the terminal type.

Optionally, the second processing module 220 is specifically configured to determine, according to the first sequence, first partial information of the terminal identification for the terminal device.

Optionally, the second communication module 210 is further configured to receive the first uplink message transmitted by the terminal device, where the first uplink message contains second partial information of the terminal identification for the terminal device. The second processing module 220 is further configured to determine the terminal identification for the terminal device according to the first partial information and the second partial information of the terminal identification.

Optionally, the first sequence is one of at least one sequence generated according to a second root sequence.

Optionally, the second root sequence or the at least one sequence is preconfigured or configured via a fourth system broadcast message transmitted by the network device 200.

Optionally, the second processing module 220 is specifically configured to determine the terminal identification for the terminal device according to the first sequence.

Optionally, a correspondence between the first sequence and the terminal identification is preconfigured.

Optionally, the network device 200 may further include the second communication module 210. The second communication module 210 is configured to transmit a fifth system broadcast message to the terminal device. The fifth system broadcast message indicates a sequence or a root sequence corresponding to each of multiple terminal identification.

Optionally, the second communication module 210 is further configured to transmit, by the network device 200, third dedicated signaling to the terminal device. The third dedicated signaling indicates a sequence or a root sequence corresponding to the terminal identification for the terminal device.

Optionally, the third dedicated signaling further indicates a valid timer associated with the sequence or the root sequence corresponding to the terminal identification and/or indicates valid area identification information associated with the sequence or the root sequence corresponding to the terminal identification.

The network device 200 in embodiments of the disclosure can implement corresponding functions of the network device in the foregoing method embodiments. For processes, functions, implementation manners, and beneficial effects corresponding to various modules (sub-modules, units, components, etc.) in the network device 200, reference can be made to the corresponding illustration in the foregoing method embodiments, which will not be repeated herein. It needs to be noted that, the described functions of various modules (sub-modules, units, components, etc.) in the network device 200 in embodiments of the disclosure can be implemented by different modules (sub-modules, units, components, etc.) or by the same module (sub-module, unit, component, etc.). For example, the first transmitting module and the second transmitting module may be different modules or the same module, and can implement corresponding functions of the network device in embodiments of the disclosure. In addition, the communication module in the embodiments of the disclosure can be implemented through a transceiver of the device, and some or all of the other modules can be implemented through a processor of the device.

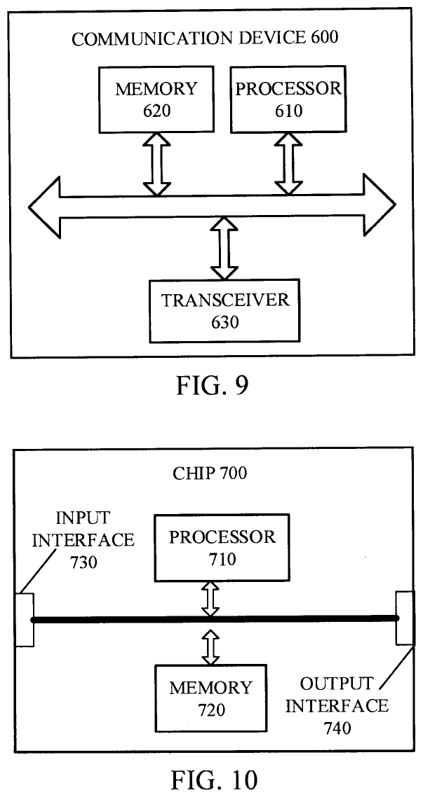

FIG. 9 is a schematic structural diagram illustrating a communication device 600 according to embodiments of the disclosure. The communication device 600 includes a processor 610. The processor 610 is configured to invoke and execute computer programs stored in a memory to perform the method in embodiments of the disclosure.

Optionally, the communication device 600 can further include a memory 620. The processor 610 is configured to invoke and execute computer programs stored in the memory 620 to perform the method in embodiments of the disclosure.

The memory 620 may be a separate device independent of the processor 610, or may be integrated in the processor 610.

Optionally, the communication device 600 can further include a transceiver 630. The processor 610 can control the transceiver 630 to communicate with other devices. Specifically, the transceiver 630 can transmit information or data to other devices, or receive information or data transmitted by other devices.

The transceiver 630 may include a transmitter and a receiver. The transceiver 630 may further include one or more antennas.

Optionally, the communication device 600 may be the network device in the embodiments of the disclosure, and the communication device 600 can implement the corresponding process implemented by the network device in various methods according to embodiments of the disclosure, which will not be repeated herein for the sake of simplicity.

Optionally, the communication device 600 may be the terminal device in the embodiments of the disclosure, and the communication device 600 can implement the corresponding process implemented by the terminal device in various methods according to embodiments of the disclosure, which will not be repeated herein for the sake of simplicity.

FIG. 10 is a schematic structural diagram illustrating a chip 700 according to embodiments of the disclosure. The chip 700 includes a processor 710. The processor 710 is configured to invoke and execute computer programs stored in a memory to perform the method in embodiments of the disclosure.

Optionally, the chip 700 may further include a memory 720. The processor 710 is configured to invoke and execute computer programs stored in the memory 720 to perform the method in embodiments of the disclosure.

The memory 720 may be a separate device independent of the processor 710, or may be integrated in the processor 710.

Optionally, the chip 700 may further include an input interface 730. The processor 710 can control the input interface 730 to communicate with other devices or chips. Specifically, the input interface 730 can obtain information or data transmitted by other devices or chips.

Optionally, the chip 700 may further include an output interface 740. The processor 710 can control the output interface 740 to communicate with other devices or chips. Specifically, the output interface 740 can output information or data to other devices or chips.

Optionally, the chip can be applied to the network device in the embodiments of the disclosure, and the chip can implement the corresponding process implemented by the network device in various methods according to embodiments of the disclosure, which will not be repeated herein for the sake of simplicity.

Optionally, the chip can be applied to the terminal device in the embodiments of the disclosure, and the chip can implement the corresponding process implemented by the terminal device in various methods according to embodiments of the disclosure, which will not be repeated herein for the sake of simplicity.

It can be understood that, the chip mentioned in the embodiments of the disclosure may also be referred to as a system-level chip, a system chip, a chip system, a system-on-a-chip chip, or the like.

The processor mentioned above may be a general-purpose processor, a digital signal processor (DSP), a field programmable gate array (FPGA), an application specific integrated circuit (ASIC), or other programmable logic devices, transistor logic devices, discrete hardware components, etc. The general-purpose processor may be a microprocessor, or may also be any conventional processor, or the like.

The memory mentioned above may be a volatile memory or a non-volatile memory, or may include both the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM).

It can be understood that, the memory mentioned above is an example rather than limitation. For example, the memory may be a static RAM (SRAM), a dynamic RAM (DRAM), a synchronous DRAM (SDRAM), a double data rate SDRAM (DDRSDRAM), an enhanced SDRAM (ESDRAM), a synclink DRAM (SLDRAM), and a direct rambus RAM (DRRAM). That is, the memory in embodiments of the disclosure is intended to include, but is not limited to, these and any other suitable types of memory.

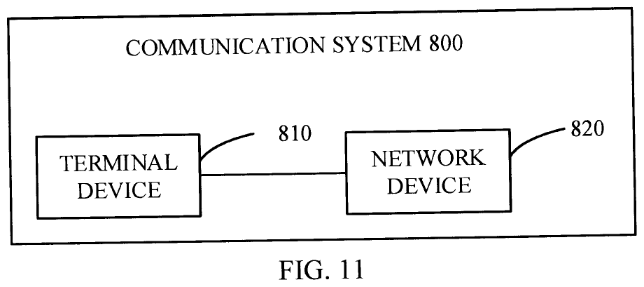

FIG. 11 is a schematic block diagram illustrating a communication system 800 according to embodiments of the disclosure. The communication system 800 includes a terminal device 810 and a network device 820.

The terminal device 810 is configured to transmit a first sequence to a network device during connection establishment. The first sequence indicates first identification information, and the first identification information is used to identify the terminal device.

The network device 820 is configured to receive the first sequence transmitted by the terminal device 810 and determine first identification information according to the first sequence.

The terminal device 810 can be configured to implement the corresponding function implemented by the terminal device in the methods in embodiments of the disclosure, and the network device 820 can be configured to implement the corresponding function implemented by the network device in the methods in embodiments of the disclosure, which will not be repeated herein for the sake of simplicity.

All or part of the above embodiments can be implemented through software, hardware, firmware, or any other combination thereof. When implemented by software, all or part of the above embodiments can be implemented in a form of a computer program product. The computer program product includes one or more computer instructions. When the computer program instructions are loaded and executed on a computer, all or part of the processes or functions of the embodiments of the disclosure are performed. The computer may be a general-purpose computer, a special-purpose computer, a computer network, or other programmable apparatuses. The computer instructions can be stored in a computer-readable storage medium, or transmitted from one computer-readable storage medium to another computer-readable storage medium. For example, the computer instructions can be transmitted from one website, computer, server, or data center to another website, computer, server, or data center in a wired manner or in a wireless manner. Examples of the wired manner may be, for example, a coaxial cable, an optical fiber, a digital subscriber line (DSL), etc. The wireless manner may be, for example, infrared, wireless, microwave, etc. The computer-readable storage medium may be any computer accessible usable-medium or a data storage device such as a server, a data center, or the like which is integrated with one or more usable media. The usable medium may be a magnetic medium (such as a soft disc, a hard disc, or a magnetic tape), an optical medium (such as a digital video disc (DVD)), or a semiconductor medium (such as a solid state disk (SSD)), etc.

It can be understood that, in various embodiments of the disclosure, the magnitude of a sequence number of each process does not mean an order of execution, and the order of execution of each process may be determined by its function and an internal logic and shall not constitute any limitation to an embodiment process in embodiments of the disclosure.

It will be evident to those skilled in the art that, for the sake of convenience and simplicity, for the specific working processes of the foregoing systems, apparatuses, and units, reference can be made to the corresponding processes in the foregoing method embodiments, which will not be repeated herein.

The above are merely specific embodiments of the disclosure and are not intended to limit the scope of protection of the disclosure. Any modification and replacement made by those skilled in the art within the technical scope of the disclosure shall be included in the scope of protection of the disclosure. Therefore, the scope of protection of the disclosure should be stated in the scope of protection of the claims.

What is claimed is:

1. A method for connection establishment, comprising:
transmitting, by a terminal device, a first sequence to a network device during connection establishment with the network device, the first sequence indicating first identification information, and the first identification information being used to identify the terminal device.

2. The method of claim 1, wherein the first identification information comprises a terminal type of the terminal device and/or at least partial information of terminal identification for the terminal device, and the terminal identification is preconfigured or configured by the network device.

3. The method of claim 2, further comprising:
transmitting, by the terminal device, a second sequence to the network device, wherein the second sequence is used to initiate registration to obtain the terminal identification for the terminal device;
wherein the second sequence is preconfigured or configured via a first system broadcast message transmitted by the network device.

4. The method of claim 1, further comprising:
transmitting, by the terminal device, a first uplink message to the network device in response to reception of a first response message from the network device;
wherein the first uplink message contains user data;
wherein the user data comprises at least one of:
data pre-stored in the terminal device;
data about surroundings collected by the terminal device; and
data obtained by the terminal device through internal operations.

5. The method of claim 1, wherein the first sequence corresponds to a terminal type of the terminal device.

6. The method of claim 5, wherein the first sequence is determined according to a preconfigured first correspondence;
wherein the first correspondence is a correspondence between the terminal type of the terminal device and the first sequence or a correspondence between the terminal type of the terminal device and a root sequence configuration for the first sequence.

7. The method of claim 5, wherein the first sequence is determined according to a third system broadcast message transmitted by the network device, wherein the third system broadcast message indicates a correspondence between a plurality of terminal types and a plurality of sequence identifiers (IDs).

8. The method of claim 1, wherein a logical position number for the first sequence corresponds to first partial information of terminal identification for the terminal device, wherein the first partial information is a higher-order truncated portion of the terminal identification or a lower-order truncated portion of the terminal identification.

9. The method of claim 8, wherein a first uplink message transmitted by the terminal device contains second partial information of terminal identification for the terminal device.

10. The method of claim 1, wherein the first sequence corresponds to terminal identification for the terminal device, wherein a correspondence between the first sequence and the terminal identification is preconfigured.

11. A terminal device, comprising:
a transceiver;
a processor coupled to the transceiver; and
a memory storing a computer program which, when executed by the processor, causes the terminal device to:
transmit a first sequence to a network device during connection establishment with the network device, the first sequence indicating first identification information, and the first identification information being used to identify the terminal device.

12. A network device, comprising:
a transceiver;
a processor coupled to the transceiver; and
a memory storing a computer program which, when executed by the processor, causes the network device to:
receive a first sequence transmitted by a terminal device during connection establishment with the terminal device; and
determine first identification information according to the first sequence, the first identification information being used to identify the terminal device.

13. The network device of claim 12, wherein the first identification information comprises a terminal type of the terminal device and/or at least partial information of terminal identification for the terminal device, and the terminal identification is preconfigured or configured by the network device.

14. The network device of claim 13, wherein the computer program is further executed by the processor to cause the network device to:
transmit to the terminal device the terminal identification for the terminal device in response to reception of a second sequence transmitted by the terminal device;
wherein the second sequence is preconfigured or configured via a first system broadcast message transmitted by the network device.

15. The network device of claim 12, wherein the computer program is further executed by the processor to cause the network device to:
transmit a first response message to the terminal device, wherein the first response message is used for instructing the terminal device to transmit a first uplink message;
wherein the first uplink message contains user data;
wherein the user data comprises at least one of:
data pre-stored in the terminal device;
data about surroundings collected by the terminal device; and
data obtained by the terminal device through internal operations.

16. The network device of claim 12, wherein the computer program is further executed by the processor to cause the network device to:
determine a terminal type of the terminal device according to the first sequence.

17. The network device of claim 16, wherein the computer program is further executed by the processor to cause the network device to:
transmit a third system broadcast message to the terminal device, wherein the third system broadcast message is used for instructing the terminal device to determine the first sequence, wherein the third system broadcast message indicates a correspondence between a plurality of terminal types and a plurality of sequence identifiers (IDs).

18. The network device of claim 12, wherein the computer program is further executed by the processor to cause the network device to:
determine, according to the first sequence, first partial information of terminal identification for the terminal device, wherein the first partial information is a higher-order truncated portion of the terminal identification or a lower-order truncated portion of the terminal identification.

19. The network device of claim 18, wherein the computer program is further executed by the processor to cause the network device to:
receive a first uplink message transmitted by the terminal device, wherein the first uplink message contains second partial information of terminal identification for the terminal device; and
determine the terminal identification for the terminal device according to the first partial information and the second partial information of the terminal identification.

20. The network device of claim 12, wherein the computer program is further executed by the processor to cause the terminal device to:
determine terminal identification for the terminal device according to the first sequence,
wherein a correspondence between the first sequence and the terminal identification is preconfigured.
